(19) United States
(12) Patent Application Publication
(10) Pub. No.: US 2023/0168178 A1
(43) Pub. Date: Jun. 1, 2023

(54) METHODS, APPARATUS, AND SYSTEMS FOR AN OPTICAL FIBER FORWARD SCATTER CHANNEL IN FLOW CYTOMETERS

(71) Applicant: CYTEK BIOSCIENCES, INC., Fremont, CA (US)

(72) Inventors: Qing Shao, Fremont, CA (US); Ming Yan, Fremont, CA (US)

(73) Assignee: CYTEK BIOSCIENCES, INC., Fremont, CA (US)

(21) Appl. No.: 17/994,395

(22) Filed: Nov. 28, 2022

Related U.S. Application Data
(60) Provisional application No. 63/284,608, filed on Nov. 30, 2021.

(51) Int. Cl. G01N 15/14

(52) U.S. Cl. CPC G01N 15/1434; G01N 15/1404; G01N 2015/1006

(57) ABSTRACT

An optical fiber forward scatter channel in a flow cytometer is disclosed. A detector system in the flow cytometer includes fiber optic cable for receiving scattered light from an incident laser light that is directed at cells/particles passing through the flow cytometer. The fiber optic cable delivers the scattered light to a sensor system, which collects data to perform analyses on the scattered light. Such analyses may include, for example, calculating the size of a cell/particle, counting cells/particles, and so on. The fiber optic cable is an inherently efficient and accurate filter for the acceptance or rejection of the scattered light.

### RELATED APPLICATIONS

This United States (U.S.) patent application is non-provisional patent application claiming priority to U.S. provisional patent application No. 63/284,608 filed on Nov. 30, 2021, by Qing Shao et al. titled OPTICAL FIBER FORWARD SCATTER CHANNEL FOR A FLOW CYTOMETER, incorporated by reference for all intents and purposes.

### FIELD

The disclosed embodiments relate generally to detectors in flow cytometer systems.

### BACKGROUND

Flow cytometry is a technology that provides rapid analysis of physical and chemical characteristics of single cells in solution. Flow cytometers utilize lasers as light sources to produce both scattered and fluorescent light signals that are read by detectors such as photodiodes or photomultiplier tubes. Cell populations can be analyzed and/or purified based on their fluorescent or light scattering characteristics. Flow cytometry provides a method to identify cells in solution and is most commonly used for evaluating peripheral blood, bone marrow, and other body fluids.

Flow cytometry is generally used in the analysis of biological cells. Examples of biological cells include Astrocyte, Basophil, B Cell, Embryonic Stem Cell, Endothelial Cell, Eosinophil, Epithelial Cell, Erythrocyte, Fibroblast, Hematopoietic Stem Cell, Macrophage, Mast Cell, Myeloid-derived suppressor cells (MDSCs), Megakaryocyte, Mesenchymal Stem Cell, Microglia, Monocyte, Myeloid Dendritic Cell, Naïve T Cell, Neurons, Neutrophil, NK Cell, Plasmacytoid Dendritic Cell, Platelets, Stromal Cells, T Follicular Helper, Th1, Th2, Th9, Th17, Th22, and Treg. Although flow cytometry was developed originally for analysis of relatively large mammalian cells, it is finding increased use by microbiologists.

The basic principle of flow cytometry is the passage of cells in single file in front of a laser so they can be detected, counted and sorted. A beam of laser light is directed at a hydrodynamically-focused stream of fluid that carries the cells. Several detectors are carefully placed around the stream, at the point where the fluid passes through the light beam. The stream of fluid is focused so that the cells pass through the laser light one at a time.

In hydrodynamic focusing, the sample fluid is enclosed by an outer sheath fluid and injected through a nozzle or cuvette. The nozzle or cuvette can be cone shaped causing a narrowing of the sheath and subsequent increase in the fluid velocity. The sample is introduced into the center and is focused by the Bernoulli effect. This allows the creation of a stream of particles in single file and is called. Under optimal conditions (laminar flow) there is no mixing of the central fluid stream and the sheath fluid.

Once the cells are lined up in a single file flow, they are passed through one or more lasers. One or more detectors are placed proximate the point where the fluid passes the laser beam. Those detector(s) in line with the light beam, and typically up to twenty degrees offset from the laser beam's axis, are used to measure forward scatter (FSC). This FSC measurement can give an estimation of a particle's size with larger particles refracting more light than smaller particles. However, particle size estimation can depend on several factors such as the sample, the wavelength of the laser, the collection angle and the refractive index of the sample and sheath fluids.

Other detector(s) are placed perpendicular to the stream and are used to measure side scatter (SSC). The SSC can provide information about the relative complexity (for example, granularity and internal structures) of a cell or particle. However, like measurements with forward scatter, measurements with side scatter can depend on various factors.

Both FSC and SSC are unique for every particle and a combination of the two may be used to roughly differentiate cell types in a heterogeneous population such as blood. However, this depends on the sample type and the quality of sample preparation. Thus, fluorescent labeling of cells/particles is generally used to obtain more detailed information about the cells/particles in a sample.

In modern flow cytometry, cells are fluorescently labelled and then excited by one or more lasers to emit light at varying wavelengths. The fluorescence can then be measured to determine the amount and type of cells present in a sample. In preparation for flow cytometric analysis, single cells in suspension are fluorescently labeled, typically with a fluorescently conjugated monoclonal antibody. Antibodies are stained with a fluorophore (fluorochrome or dye) and introduced to the cell population, where they bind to cell markers.

Fluorophores are fluorescent markers used to detect the expression of cellular molecules such as proteins or nucleic acids. They accept light energy (for example, from a laser) at a given wavelength and re-emit it at a longer wavelength. These two processes are called excitation and emission. Emission follows excitation extremely rapidly, commonly in nanoseconds and is known as fluorescence.

When a fluorophore absorbs light, its electrons become excited and move from a resting state, to a maximal energy level called the excited electronic singlet state. The amount of energy required for this transition will differ for each fluorophore. The duration of the excited state depends on the fluorophore and typically lasts in a range from one to ten nanoseconds. The fluorophore then undergoes a conformational change, the electrons fall to a lower, more stable energy level called the electronic singlet state, and some of the absorbed energy is released as heat. The electrons subsequently fall back to their resting state releasing the remaining energy as fluorescence.

Cells express characteristic (proteins, lipids, glycosylation, etc.) that can be used to help distinguish unique cell types. These markers are referred to as cell markers that can be expressed both extracellularly on the cells surface (surface or extracellular cell marker) or as an intracellular molecule (intracellular cell marker). Markers are generally functional membrane proteins involved in cell communication, adhesion, or metabolism. Surface and intracellular cell markers can be used for a variety of cell types including immune cells, stem cells, central nervous system cells, and more.

Antibodies can specifically bind to cell markers. The affinity between the paratope region of antibodies and the corresponding epitope region of cell markers are a very useful way to identify a specific cell population. However, the cell markers will often be expressed on more than one cell type. Therefore, flow cytometry staining strategies have led to methods for immunophenotyping cells with two or more antibodies simultaneously.

CD markers (cluster of differentiation markers) are used for the identification and characterization of leukocytes and the different subpopulations of leukocytes. Many immunological cell markers are CD markers and these are commonly used for detection in flow cytometry of specific immune cell populations and subpopulations. The majority of flow cytometer analysis are conducted on leukocytes; however, the general principle of the invention is applicable to other bodily fluids.

The fluorescently labelled cell components are excited by the laser and emit light at a longer wavelength than the light source. The detectors therefore pick up a combination of scattered and fluorescent light. The intensity of the emitted light is directly proportional to the antigen density or the characteristics of the cell being measured. Data from the detectors can then analyzed by a computer using special software. The computer can be coupled in communication with the flow cytometer.

Fluorescence measurements taken at different wavelengths can provide quantitative and qualitative data about fluorophore-labeled cell surface receptors or intracellular molecules such as DNA and cytokines. Most flow cytometers use separate channels and detectors to detect emitted light, the number of which vary according to the instrument and the manufacturer.

The need to understand the mechanisms and pathways of immune evasion seen either post immunotherapy or during natural immune responses to cancer, autoimmunity, and infectious diseases, requires methods and protocols which will enable a deeper profiling of the immune system. Greater characterization of immune subpopulations allows for more informed decisions regarding the identification of targetable biomarkers and the development of new therapeutic approaches. Unraveling the complexity of the human immune response requires the ability to perform high throughput, in-depth analysis, at the single cell and population levels.

Sample availability can often be limited, especially in cases of clinical trial material, when multiple types of testing are required from a single sample or timepoint. Maximizing the amount of information that can be obtained from a single sample not only provides more in-depth characterization of the immune system, but also serves to address the issue of limited sample availability.

### BRIEF SUMMARY

The embodiments are best summarized by the claims. However briefly, in accordance with one embodiment, a method is disclosed including flowing a cell/particle in a flow cell through an optical axis of an incident laser light; striking portions of the cell/particle with the incident laser light to generate forward scattered laser light; focusing the forward scattered laser light into a first end of an optical fiber; directing the forward scattered laser light towards a second end of the optical fiber; and launching the forward scattered laser light out of the second end of the optical fiber into a sensor subsystem to detect the forward scattered laser light. The method can further include with the optical fiber, filtering out unwanted scattered light from spatial and angular perspectives. The method can further include with the optical fiber, filtering the forward scattered laser light into a pass band of wavelengths of forward scattered laser light; and detecting an intensity of the pass band of wavelengths of forward scattered laser light. The pass band of wavelengths of forward scattered laser light is in a range inclusively between 492 nanometers and 484 nanometers around 488 nanometers. The method can further include receiving the forward scattered laser light out from the second end of the optical fiber; focally reimaging the forward scattered laser light into a photodiode detector; filtering the focused forward scattered laser light into a pass band of wavelengths of forward scattered laser light into the photodiode detector; and detecting an intensity of the pass band of wavelengths of forward scattered laser light. The method can further include adjusting a signal gain of the photodiode detector to detect the intensity of the pass band of wavelengths of the forward scattered laser light. The method can further include prior to the striking, blocking the incident laser light. The incident laser light is blocked while the cell/particle is outside the optical axis of the incident laser light. The method can further include after the striking, blocking the incident laser light, wherein the incident laser light is blocked while the cell/particle is outside the optical axis of the incident laser light. The photodiode detector is an avalanche photodiode.

In accordance with another embodiment, a forward scatter light detector system is disclosed including an obscuration device aligned in an optical axis of a laser to block incident laser light that is unshattered by a cell/particle; a first lens having an optical axis aligned with the optical axis of the laser, the first lens spaced apart from an interrogation region in a flow cell of cells/particles by a first distance, the first lens spaced apart from the obscuration device by a second distance less than the first distance, the first lens to received forward scattered laser light that is scattered by the cells/particles that are struck by incident laser light; an optical fiber having a first end and a second end opposite the first end, the optical fiber having an optical axis at the first end aligned with the optical axis of the laser, the first end of the optical fiber spaced apart from the first lens by a third distance; and a sensor subsystem having an optical axis aligned with the optical axis of the optical fiber at the second end. The sensor subsystem receives forward scattered laser light from the second end of the optical fiber and detects an intensity of the forward scattered laser light.

In one case, the sensor subsystem of forward scatter light detector system can include a bandpass filter having a passband range of wavelengths; and a first photodetector having an optical axis aligned with the optical axis of the optical fiber at the second end. The bandpass filter has an optical axis aligned with the optical axis of the optical fiber at the second end. The bandpass filter is spaced apart from the second end of the optical fiber to receive forward scattered laser light from the second end of the optical fiber. The bandpass filter filters out scattered light outside the passband range and passes through the forward scattered laser light within the passband range. The first photodetector receives the band passed forward scattered laser light to detect an intensity of light therein.

In another case, the sensor subsystem of forward scatter light detector system can include a second lens having an optical axis aligned with the optical axis of the optical fiber at the second end, the second lens spaced apart from the second end of the optical fiber by a fourth distance to receive forward scattered laser light from the second end of the optical fiber and focally reimage the forward scattered laser light into a focal point; a bandpass filter having a passband range of wavelengths; and an avalanche photodiode detector having an optical axis aligned with the optical axis of the optical fiber at the second end. The bandpass filter has an optical axis aligned with the optical axis of the optical fiber at the second end. The bandpass filter is spaced apart from the second lens to receive the reimaged forward scattered laser light from the second lens. The bandpass filter filters out scattered light outside the passband range and passes through the forward scattered laser light within the passband range. The avalanche photodiode detector receives the band passed forward scattered laser light to detect an intensity of light therein. The first distance and the third distance are a focal length of the first lens; and the fourth distance is a focal length of the second lens.

In one case, the obscuration device is an obscuration bar. In another case, the obscuration device is an angled mirror to reflect the incident laser light along the optical axis of the laser that is unscattered by a cell/particle. In which case, the forward scatter light detector system can include a second photodetector spaced apart from the angled mirror, the second photodetector to receive the reflected incident laser light and sense the intensity of the reflected incident laser light. The optical axis of the angled mirror has a 45-degree angle with the optical axis of the laser generating the incident laser light such that the incident laser light can be perpendicularly reflected by 90 degrees into the photodetector.

The forward scatter light detector system can further include a first mechanical coupler coupled to the optical fiber near the first end to hold the first end such that the optical axis of the optical fiber is aligned with the optical axis of the laser and a second mechanical coupler coupled to the optical fiber near the second end to hold the second end such that the optical axis of the optical fiber is aligned with the optical axis of the sensor subsystem.

In accordance with yet another embodiment, a flow cytometer system is disclosed including a platform; a flow cell mounted to the platform; one or more lasers mounted to the platform; a first lens having an optical axis aligned with the optical axis of the one or more lasers; an obscuration device mounted to the platform between the flow cell and the one or more lasers; an optical fiber having a first end mounted to the platform and a second end opposite the first end mounted to the platform; and a sensor subsystem mounted to the platform having an optical axis aligned with the optical axis of the optical fiber at the second end. The one or more lasers respectively generate one or more laser beams directed to an interrogation region in the flow cell. The first lens is spaced apart from the interrogation region in a flow cell by a first distance. The first lens receives forward scattered laser light that is scattered by cells/particles in the interrogation region that are struck by the one or more laser beams. The obscuration device is spaced apart from the first lens by a second distance less than the first distance. The obscuration device is further aligned with the optical axis of the one or more lasers to block incident laser light that is unscattered by a cell/particle. The optical fiber has an optical axis at the first end to receive the one or more laser beams focused by the first lens. The first end of the optical fiber is spaced apart from the first lens by a third distance. The sensor subsystem receives forward scattered laser light from the second end of the optical fiber and detects an intensity of the forward scattered laser light.

The sensor subsystem can include a second lens having an optical axis aligned with the optical axis of the optical fiber at the second end; a bandpass filter having a passband range of wavelengths; and an avalanche photodiode detector having an optical axis aligned with the optical axis of the optical fiber at the second end. The second lens is spaced apart from the second end of the optical fiber by a fourth distance to receive forward scattered laser light from the second end of the optical fiber and focally reimage the forward scattered laser light into a focal point. The bandpass filter has an optical axis aligned with the optical axis of the optical fiber at the second end. The bandpass filter is spaced apart from the second lens to receive the reimaged forward scattered laser light from the second lens. The bandpass filter filters out scattered light outside the passband range and passes through the forward scattered laser light within the passband range. The avalanche photodiode detector receive the band passed forward scattered laser light to detect an intensity of light therein.

### BRIEF DESCRIPTIONS OF THE DRAWINGS

Various embodiments are illustrated by way of example, and not by way of limitation, in the Figures of the accompanying drawings.

FIG. 1A is a conceptual diagram of a cell sorter system (a sorting flow cytometer system) and a flow cytometer system.

FIG. 1B is a schematic diagram of a full spectrum flow cytometer.

FIG. 2A illustrates light scatter off of two different sized cells/particles.

FIG. 2B illustrates light scatter off of a cell/particle.

FIG. 2C illustrates light scatter off of a different sized cell/particle.

FIG. 3A is a conceptual diagram of a side view of example side scatter in a detector system of a flow cytometer.

FIG. 3B is another conceptual diagram of a top view of example side scatter in a detector system of a flow cytometer.

FIG. 4 is a conceptual diagram of a side view of a detector system of a flow cytometer.

FIG. 5A is a conceptual diagram of a detector system having an optical fiber (e.g., fiber optic cable).

FIG. 5B is a conceptual diagram of another detector system having an optical fiber (e.g., fiber optic cable) and an avalanche photodiode (APD) detector.

FIG. 6A illustrates a view of an end of the optical fiber.

FIG. 6B illustrates more cross-sectional view along the optical axis of the optical fiber.

FIG. 7A is a conceptual block diagram of a detector system having an optical fiber (e.g., fiber optic cable) and a light loss detector.

FIG. 7B is another conceptual block diagram of a detector system having an optical fiber (e.g., fiber optic cable), a light loss detector, and an avalanche photodiode (APD) detector.

FIG. 8A illustrates a top view of a portion of a flow cytometer system with an optical fiber forward scatter detection subsystem.

FIG. 8B illustrates a perspective view of a portion of the flow cytometer system shown in FIG. 8A.

It will be recognized that some or all of the Figures are for purposes of illustration and do not necessarily depict the actual relative sizes or locations of the elements shown. The Figures are provided for the purpose of illustrating one or more embodiments with the explicit understanding that they will not be used to limit the scope or the meaning of the claims.

### DETAILED DESCRIPTION

In the following detailed description of the embodiments, numerous specific details are set forth. However, it will be obvious to one skilled in the art that the embodiments may be practiced without these specific details. In other instances, well known methods, procedures, components, and circuits have not been described in detail so as not to unnecessarily obscure aspects of the embodiments. The various sections of this description are provided for organizational purposes. However, many details and advantages apply across multiple sections.

### System Overview

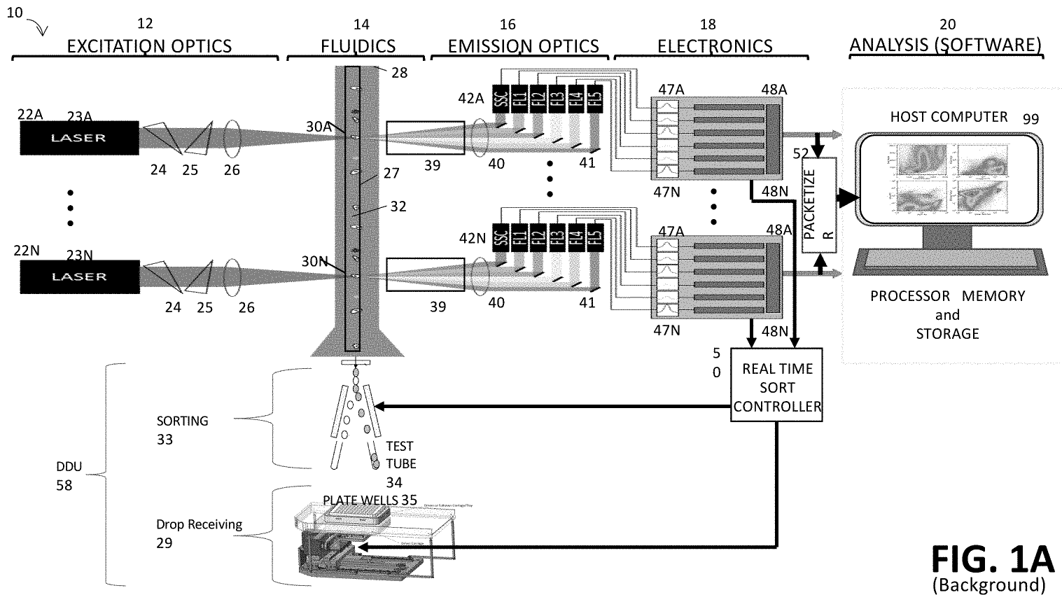

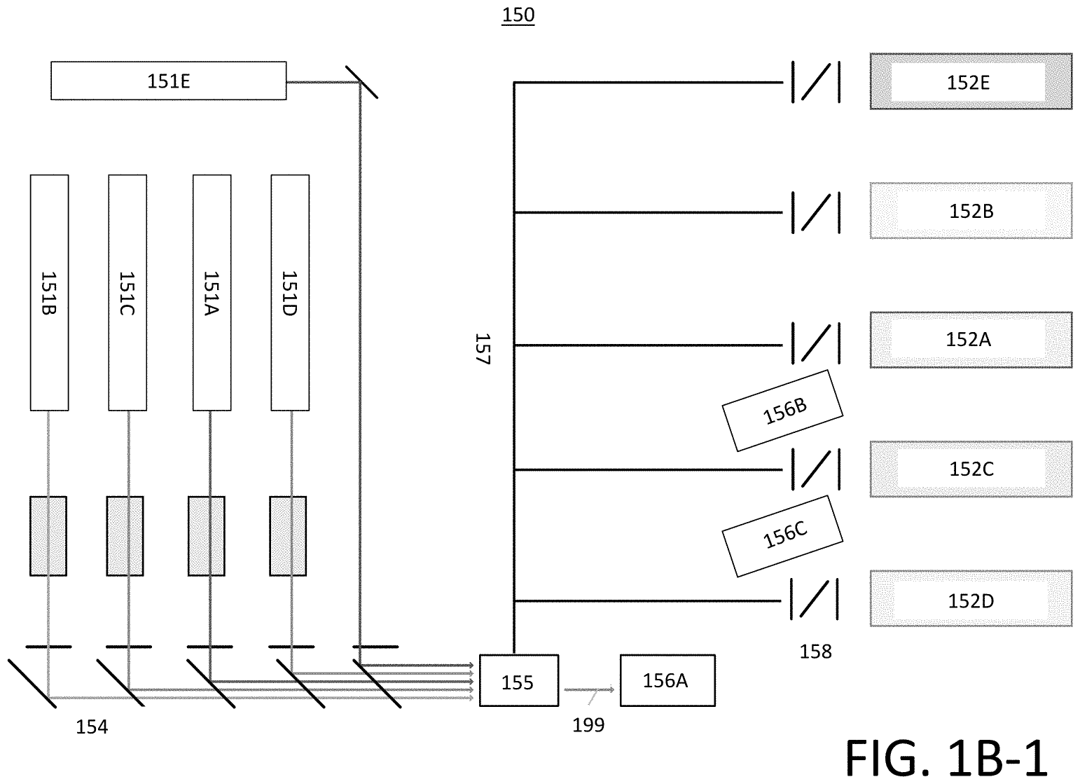

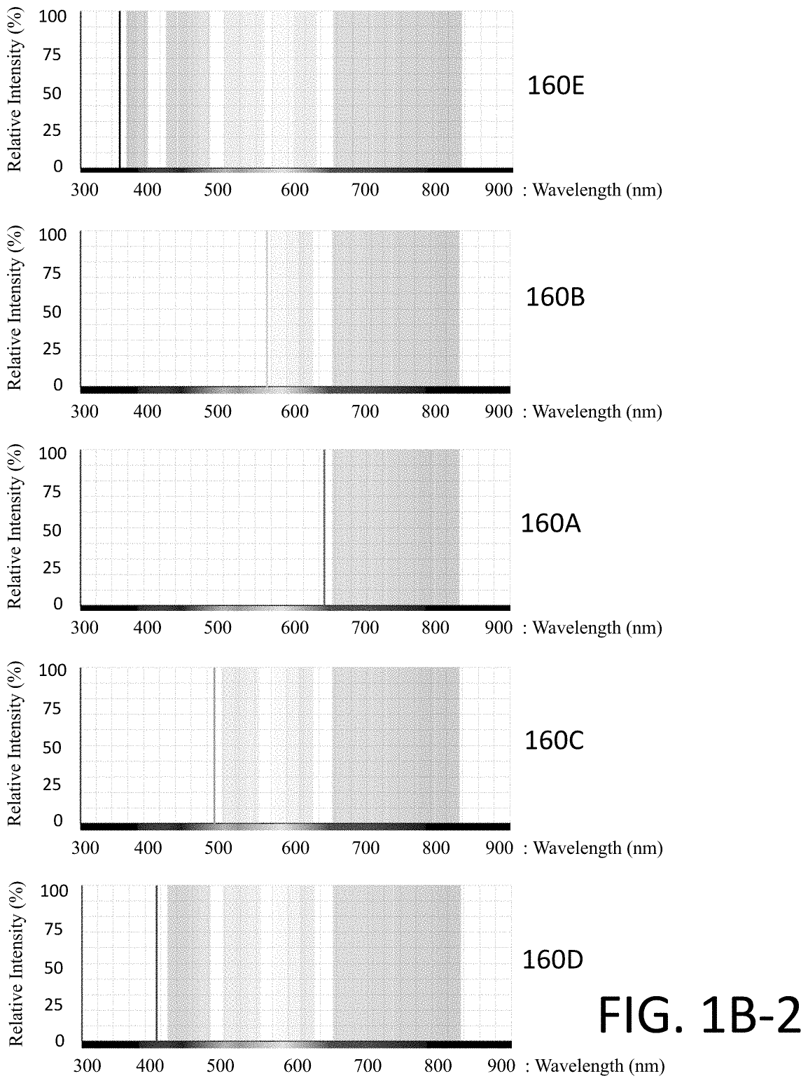

FIG. 1A is a basic conceptual diagram of a cell sorter system (sorting flow cytometer) 10. Five major subsystems of the system 10 include an excitation optics system 12, a fluidics system 14, an emission optics system 16, an acquisition system 18, and an analysis system 20. The fluidics system 14 can include a sample loading system (see sample input station 130 shown in FIG. 1C), an interrogating system 28, a cell sorting system 33, and a droplet deposition (droplet receiving) system 29. Generally, a “system” and “subsystem” includes (electrical, mechanical, and electro-mechanical) hardware devices, software devices, or a combination thereof.

The excitation optics system 12 includes, for example, a plurality (e.g., two to five) of excitation channels 22A-22N each having a different laser device 23A-23N and one or more optical elements 24-26 to direct the different laser light to optical interrogation regions 30A-30N spaced apart along a line in a flow channel 27 of a flow cell 28. Example optical elements of the one or more one or more optical elements 24-26 include an optical prism and an optical lens. The excitation optics system 12 illuminates an optical interrogation region 30 in a flow cell 28. The fluidics system 14 carries a fluid sample 32 surrounded by a sheath fluid through each of a plurality of optical interrogation regions 30A-30N in the flow cell/flow channel.

The emission optics system 16 includes a plurality of detector arrays 42A-42N each of which, for example, includes one or more optical elements 40, such as an optical fiber and one or more lenses to direct fluorescent light and/or (forward, side, back) scattered light to various electro-optical detectors (transducers), including a side scatter (SSC) channel detector and a plurality (e.g., 16, 32, 48, 64) of fluorescent wavelength range optical detectors in each array, such as a first fluorescent optical detector (FL1) receiving a first wavelength range of fluorescent light, a second fluorescent optical detector (FL2) receiving a second wavelength range of fluorescent light, a third fluorescent optical detector (FL3) receiving a third wavelength range of fluorescent light, a fourth fluorescent optical detector (FL4) receiving a fourth wavelength range of fluorescent light, a fifth fluorescent optical detector (FL5) receiving a fifth wavelength range of fluorescent light, and so on to an Nth fluorescent optical detector (FLN) receiving an Nth wavelength range of fluorescent light. Each of the detector arrays 42A-42N receives light corresponding to the cells/particles that are struck and/or one or more fluorescent dyes that attached thereto and excited by the differing laser light in interrogation regions/points 30A-30N along the flow channel 27 of the flow cell 28 by each of the corresponding plurality of lasers 23A-23N. The emission optics system 16 gathers photons emitted or scattered from passing cells/particles and/or a fluorescent dyes attached to the cells/particles. The emission optics system 16 directs and focuses these collected photons onto the electro-optical detectors SSC, FL1, FL2, FL3, FL4, and FL5 in each detector array, such as by fiber optic (optical fibre) cables 39, one or more one or more lenses 40, and one or more mirrors/filters 41. Electro-optical detector SSC is a side scatter channel detector detecting light that scatters off the cell/particle. The electro-optical detectors FL1, FL2, FL3, FL4, and FL5 are fluorescent detectors may include band-pass, or long-pass, filters to detect a particular and differing fluorescence wavelength ranges from the different fluorescent dyes excited by the different lasers. Each electro-optical detector converts photons into electrical pulses and sends the electrical pulses to the acquisition (electronics) system 18.

For each detector array 42A-42N, the acquisition (electronics) system 18 includes one or more analog to digital converters 47A-47N and one or more digital storage devices 48A-48N that can provide a plurality of detector channels (e.g., 16, 32, 48 or 64 channels) of spectral data signals. The spectral data signals can be signal processed (e.g., digitized by the A/Ds) and time stamped, and packeted together by a packetizer 52 into a data packet corresponding to each cell/particle in the sample). These data packets for each cell/particle can be sent by the acquisition (electronics) system 18 to the analysis system 20 for further signal processing (e.g., converted/transformed from time domain to wavelength domain) and overall analysis. Alternatively, or conjunctively, time stamped digital spectral data signals from each channel that is detected can be directly sent to the analysis system 20 for signal processing.

The analysis system 20 includes a processor, memory, and data storage to store the data packets of time stamped digital spectral data associated with the detected cells/particles in the sample. The analysis system 20 further includes software with instructions executed by the processor to convert/transform data from the time domain to data in a wavelength/frequency domain and stich/merge data together to provide an overall spectrum for the cell/particle/dyes excited by the different lasers and sensed by the detector arrays. With detection of the type of cell/particle through the one or more fluorescent dyes attached thereto, a count of the cells/particles can be made in a sample processed by a flow cytometer and/or cell sorter.

In some cases, it is desirable to sort out the cells in a sample for further analysis with a cell sorter (sorting flow cytometer). Accordingly, the spectral data signals can also be processed by a real time sort controller 50 in the acquisition (electronics) system 18 and used to control a sorting system 33 to sort cells or particles into one or more test tubes 34. In which case, the sorting system 33 is in communication with the real time sort controller 50 of the acquisition (electronics) system 18 to receive control signals. Instead of test tubes 34, the spectral data signals can also be processed by the real time sort controller 50 of the acquisition (electronics) system 18 and used to control both the sorting system 33 and a droplet deposition system 29 to sort cells or particles into wells 35 of a moving capture tray/plate. In which case, both the droplet deposition system 29 and the sorting system 33 are in communication with the acquisition (electronics) system 18 to receive control signals. In an alternate embodiment, the analysis system 20 can generate these control signals from analyzing the spectral data signals in order to sort out different cells/molecules and control the sorting system 33 and the droplet deposition system 29 to capture the drops of samples with cells/particles into one or more wells 35 of the plurality of wells in the capture tray/plate.

U.S. patent application Ser. No. 15/817,277 titled FLOW CYTOMETERY SYSTEM WITH STEPPER FLOW CONTROL VALVE filed by David Vrane on Nov. 19, 2017, now issued as U.S. patent Ser. No. 10/871,438; U.S. patent application Ser. No. 15/659,610 titled COMPACT DETECTION MODULE FOR FLOW CYTOMETERS filed by Ming Yan et al. on Jul. 25, 2017; and U.S. patent application Ser. No. 15/942,430 COMPACT MULTI-COLOR FLOW CYTOMETER HAVING COMPACT DETECTION MODULE filed by Ming Yan et al. on Mar. 30, 2018, each of which disclose exemplary flow cytometer systems and subsystems, are all incorporated herein by reference for all intents and purposes. U.S. Pat. No. 9,934,511 titled Rapid Single Cell Based Parallel Biological Cell Sorter issued to Wenbin Jiang on Jun. 19, 2016, discloses a sorting flow cytometer (cell sorter) system that is incorporated herein by reference for all intents and purposes.

### Full Spectrum Flow Cytometer

Referring now to FIG. 1B, a schematic diagram of a full spectrum flow cytometer 150 is shown. United States (US) Patent application Ser. No. 15/659,610 titled COMPACT DETECTION MODULE FOR FLOW CYTOMETERS filed on Jul. 25, 2017 by inventors Ming Yan et al., and U.S. patent application Ser. No. 15/498,397 titled COMPACT MULTI-COLOR FLOW CYTOMETER filed on Apr. 26, 2017 by David Vrane et al. describes further details of flow cytometers, both of which are incorporated herein by reference for all intents and purposes.

The full spectrum flow cytometer 150 can be variably configured with different numbers of lasers and different numbers of detector modules. In one embodiment, the full spectrum flow cytometer 150 can include five lasers (Red 640 nm, Yellow-Green 561 nm, Blue 488 nm, Violet 405 nm, and UV 355 nm) 151A-151E and five detector modules 152A-152E as shown in FIG. 1B to provide full spectrum analysis. With five detector modules, each of the detector modules (Red, Yellow-Green, Blue, Violet, and UV) 152A-152E can be associated with one of the five lasers as shown in FIG. 1B. Each of the five lasers generate laser light of five different wavelengths such as ultraviolet (UV) 355 nm, Violet 405 nm, Blue 488 nm, Yellow Green 561 nm, and Red 640 nm. Equipped with five lasers and five detectors, the full spectrum flow cytometer 150 can be used to develop color panels with 28 or more colors.

The optical paths of the laser light for each of the five lasers (UV 355 nm, Violet 405 nm, Blue 488 nm, Yellow Green 561 nm, and Red 640 nm) is shown in FIG. 1B. The lasers are spatially separated, each having an independent optical path to the flow cell 155. One or more optical components 154, such as mirrors, lenses, and filters, can be used to direct the laser light of each laser into the flow cell 155 to strike particles/cells in the sample fluid as they pass by an interrogation region.

After striking a particle in the flow cell 155, the fluorescent light is collected and directed through a plurality of optical fibers 157 and one or more optical elements (e.g., lenses) 158 into each of the individual detector modules 152A-152E. Each of the detector modules 152A-152E uses a sequential array of a plurality of avalanche photodiodes (APD) as the photodetectors.

The full spectrum flow cytometer 150 can further include a plurality of scatter detectors, including without limitation a forward scatter (FSC) detector 156A, a blue side scatter detector 156B near the lens/filters for the red detector module, and a violet side scatter detector 156C near the lens/filters for the blue detector module. The plurality of scatter detectors are typically used to control data captured by the detector modules in the flow cytometer and data storage in a storage device.

The FSC detector 156A can also determine a measure of the size of a cell/particle. To improve sensitivity, the FSC detector can be positioned remotely away from the flow cell using an optical fiber (e.g., fiber optic cable) 199. The optical fiber (e.g., fiber optic cable) 199 captures the forward scattered light and redirects it to the remotely located FSC detector 156A. The remote location allows for improvements in optics and the photo detector of the FSC detector channel 156A. The optical fiber (e.g., fiber optic cable) 199 itself, with a core and a cladding, provides advantages as further explained herein.

Each of the detector modules 152A-152E can capture a plurality of raw digital data for a given particle/cell as each laser beam of the plurality of lasers strike the same particle. The plurality of raw digital data is captured at slightly different times (laser delay) as the marked particle/cell passes by each laser beam in the flow channel. For example, the yellow/green laser 151B strikes the particle generating a first set of raw digital data; the violet laser 151D strikes the particle generating a second set of raw digital data; the blue laser 151C strikes the particle generating a third set of raw digital data; the red laser 151A strikes the particle generating a fourth set of raw digital data; and the UV laser 151E strikes the particle generating a fifth set of raw digital data for the same particle. If the plurality of lasers 151A-151E are arranged in a different order along the flow channel, the sequential order of generation of raw digital data by the same particle will be different. While an associated detector module is capturing light from the module's associated lasers, data from detectors in the other detector modules can be ignored. For example, at the time when the red laser 151A strikes the particle/cell, the data from the red detector module 152A is captured while the data from the UV, violet, yellow/green, and blue detector modules can be ignored.

With the addition of the UV laser 151A and having five detector modules providing sixty-four (64) fluorescence detectors, the full spectrum flow cytometer 150 has the power to take highly multiplexed assays beyond thirty (30) colors. The incorporation of the UV laser 151A allows the full spectrum flow cytometer 150 to perform at a different wavelength and discriminate different colors than those systems without. The UV laser enables the use of UV light excited fluorochromes, such as BUV737 and BUV395 fluorochromes, giving researchers additional flexibility on how they design experiments for a sample of particles.

### Light Scattering

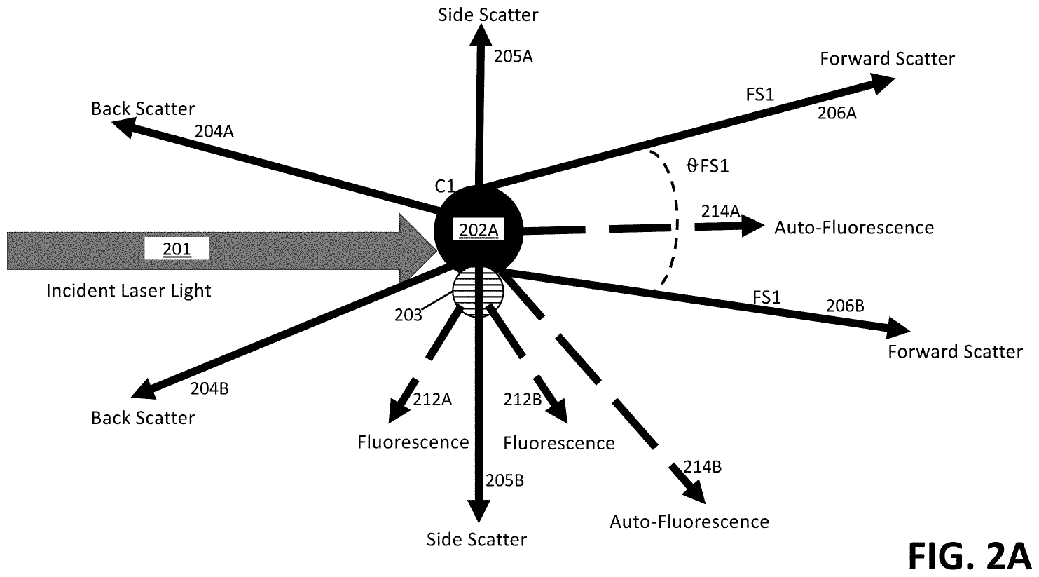

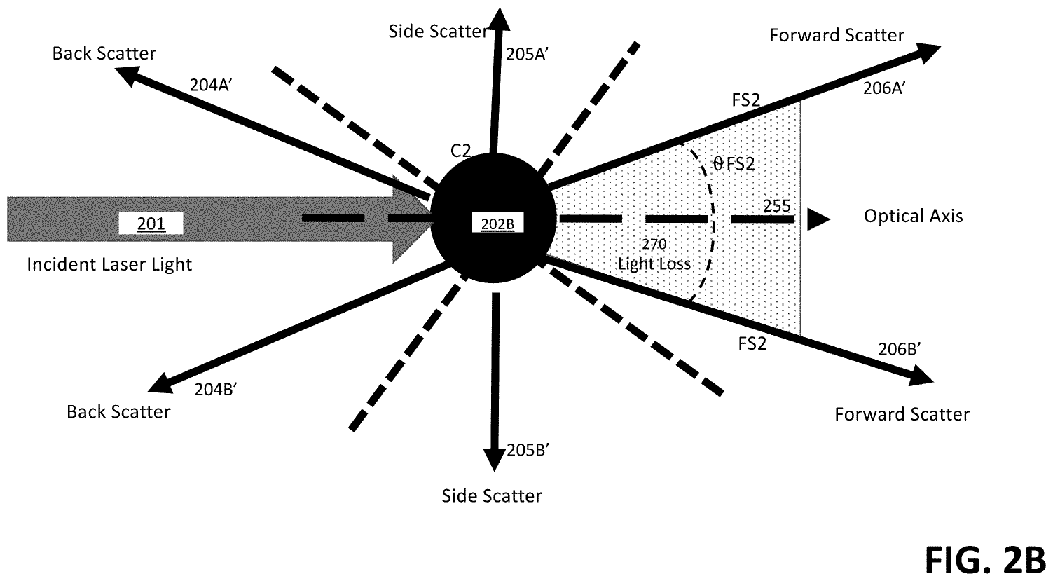

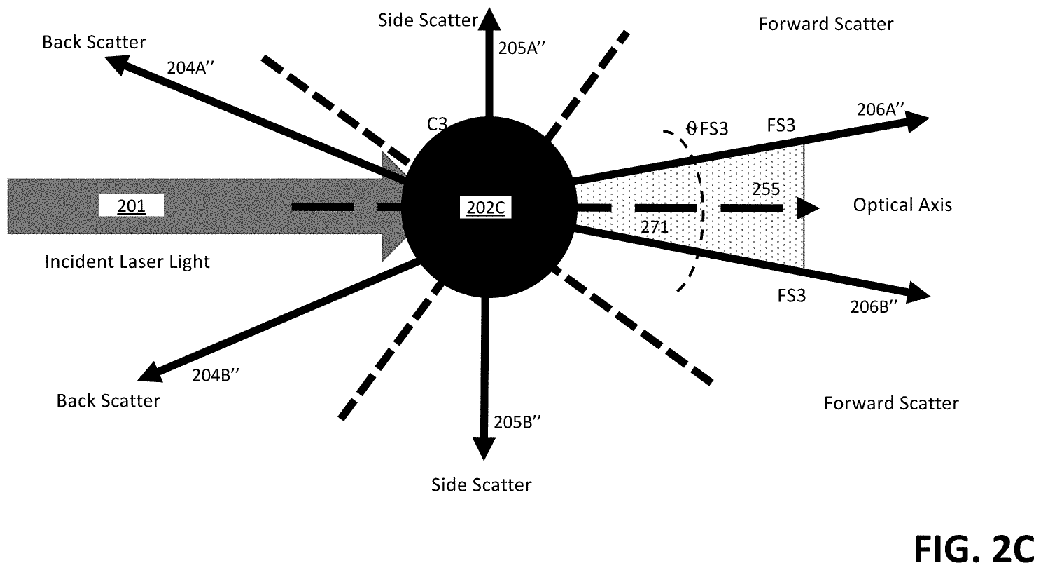

Referring to FIGS. 2A-2C, scattered light off a cell or particle 202A,202B,202C (collectively referenced to cell/particle 202) can go in four general directions or quadrants over ninety degrees around an optical axis. In these four quadrants the scattered light can be described as back scattered light 204A,204B, forward scattered light 206A,206B, left side scattered light 205A, and right side scattered light 205B. The left side scattered light 205A and the right scattered light 205B can be generally referred to as side scattered light. Forward scattered light 206A,206B can be defined as light that is scattered between angles greater than 315 degrees and less than or equal to 45 degrees (e.g., plus or minus 45 degrees with a 0-degree axis or parallel axis) with the direction of the illuminating light beam axis. Right side scattered light 205B can be defined as light that is scattered between angles greater than 45 degrees and less than or equal to 135 degrees (e.g., plus or minus 45 degrees with a 90-degree axis or perpendicular axis) with the direction of the illuminating light beam axis. Backward scattered light 204A,204B may be defined as light that is scattered between angles greater than 135 degrees and less than or equal to 225 degrees (e.g., plus or minus 45 degrees with a 180-degree axis or parallel axis, in the opposite direction to the illuminating light beam) with the direction of the light beam axis. Left side scattered light 205A can be defined as light that is scattered at angles greater than 225 degrees and less than or equal to 315 degrees (e.g., plus or minus 45 degrees with a 270-degree axis or perpendicular) with the direction FS1 of the illuminating light beam axis.

FIG. 2A is a conceptual diagram of an incident laser 201 striking a cell/particle 202A and a fluorescent die 203 attached to the cell/particle 202A. The incident laser is typically projected at a right angle to the excitation optics 12 of FIG. 1A. The scattered light 204A-206B off the cell/particle 202 can generate side scattered light 205A, forward scattered light 206A,206B, or back scattered light 204A,204B, and can go in four general directions or quadrants over ninety degrees. The cell/particle can absorb some energy from the laser light and generate autofluorescence light 214A,214B in any and all directions. The fluorescent dye 203 can absorb some energy from the laser light and generate fluorescent light 212A,212B in any and all directions.

FIG. 2B is a conceptual diagram of an incident laser 201 striking a cell/particle 202B. The forward scattered light FS2 can provide information (e.g., intensity, collection angle) to gauge the size of the cell/particle 202B when its size is greater than the wavelength of the incident laser light 201. A cell/particle 202B of a size C2 generates a cone of forward scatter light FS2 when the cell/particle 202B is struck at center by a laser light 201 along the optical axis 255. An image of the cone passed on to a detector can provide collection angle information.

Light scatter intensity has a strong dependence on the relationship between the size of the particle to the wavelength of the incident (excitation) laser. Cells/particles with diameters that are larger than the wavelength of the incident laser light 201 will scatter light with a different pattern than cells/particles that are smaller than the wavelength of the laser. For example, assume 488 nm wavelength for the laser light 201, particles or cells with diameters larger than about one-half (0.5) micron will scatter light differently than particles with diameters significantly smaller than one-half (0.5) micron.

German physicist Gustav Mie formed a physical theory, Mie's theory, that predicts and explains the behavior of light scattering of cells/particles with diameters larger than the wavelength of the incident laser light. Mie's light scattering theory predicts that the intensity of scattered light from a larger spherical particle has a strong angular dependence. For smaller particles than the wavelength of the incident laser light, Raleigh scattering theories may be useful to use with side scattered light.

FIG. 2C is another conceptual diagram of an incident laser 201 striking a cell/particle 202C. In FIG. 2C, a cell/particle 202C of a different size C2 generates a cone of forward scatter light FS3. When a laser light along the optical axis strikes the center of cell 202C, the cell 202C generates a cone of forward scatter light FS3. The cone of forward scatter light FS3 differs from the cone of forward scatter light FS2.

In FIGS. 2B-2C, the diameter of the cone of forward scatter light FS2, FS3 is inversely proportional to the diameter of the cell/particle 202B,202C and can be used to determine a cell/particle size C2, C3. If the flow cytometer system is calibrated with a known cell/particle size, the predetermined cell diameter and calibrated cone diameter can be ratioed with the measured cone diameter and unknown diameter to determine the unknown diameter of a cell/particle being sampled. Accordingly, detecting the forward scattered light can be useful to measure in determining cell/particle size.

### Forward Scatter Detection Channel

There are various ways to detect the cone of forward scattered light. A forward scatter detection channel in a flow cytometer and cell sorter is provided to detect forward scattered light.

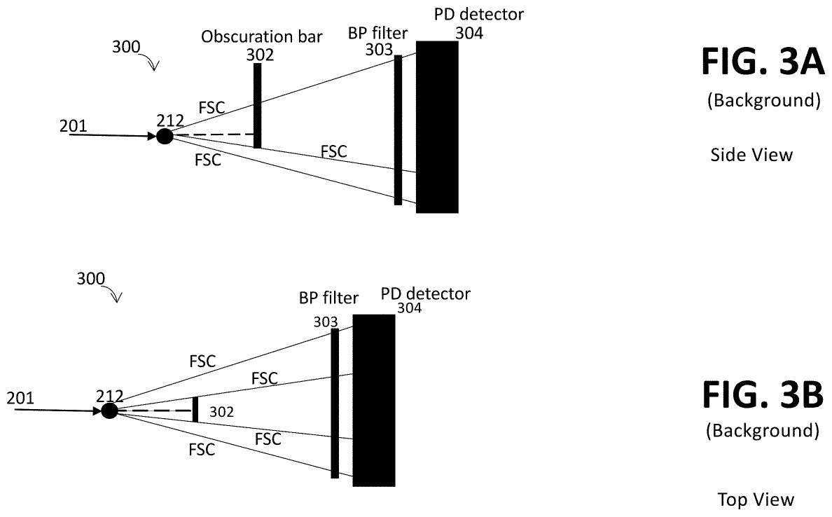

FIG. 3A is a conceptual diagram of a side view of example side scatter in a detector system 300A of a flow cytometer. FIG. 3B is a conceptual diagram of a top view of example side scatter in a detector system 300B of a flow cytometer. Forward scatter versus side scatter gating (FSC vs SSC gating) is commonly used to identify cells of interest based on size and granularity (complexity). Generally, the amount forward scatter light can be used to calculate the size of a cell/particle 202. Generally, side scatter light can indicate the complexity or granularity of a cell.

Laser light is used as incident light into a flow cell cuvette to excite the cell/particle of interest. The main incident laser light 201 is blocked by obscuration bar (stick shape) 302 when no cell/particle is present. Forward scattered (FSC) light can go around the obscuration bar 302 to reach a narrow band pass filter 303. The pass band of the filter 303 is associated with the incident wavelength of the laser light 201. In one embodiment, the band bass filter 303 enables light with a wavelength around 488 nm (+/−4 nm) to pass through while filtering out other wave lengths outside the pass band. The passed wavelengths of scattered light reach the photodiode (PD) detector 304. The photodiode (PD) detector 304 is a transducer that coverts an optical signal (scattered laser light) into an electrical signal. In this subsystem, the acceptance angle of scattered light is determined by the size (aperture) of the PD detector 304 and the distance between the cell/particle 202 and the PD detector 304.

A smaller particle (small diameter particle) has a larger scattering angle than a large particle (large diameter particle). To increase the sensitivity in detecting a smaller particle, a capability to detect a larger scattering angle is desirable. To increase the sensitivity (e.g., signal to noise ratio) of detecting the intensity of forward scattered light, a confocal design can be used to eliminate light some noise (e.g., background environmental noise) that makes its way into the cuvette of the flow cell and strikes or bypasses the cell/particle in the cuvette.

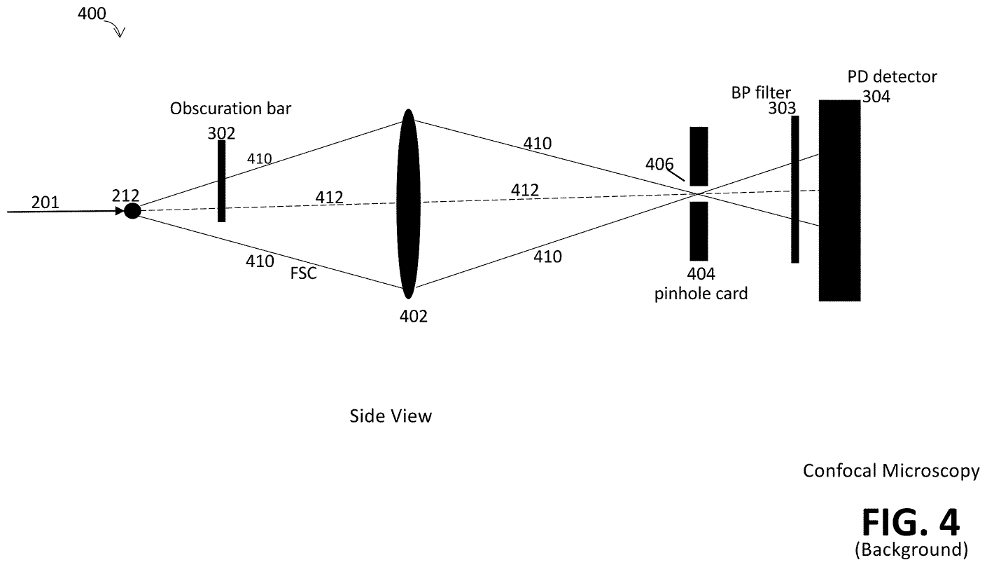

FIG. 4 is side view of a conceptual diagram of a forward scatter detector subsystem 400 of a flow cytometer. The forward scatter detector subsystem 400 has a confocal microscopy design. In optics, confocal means having the same focal point or same image point. Confocal microscopy provides a means of rejecting the out-of-focus light from reaching the detector 304. A lens 402 reimages the scattered light 410 to a detector 304 by using a pinhole card 404 having a spatial filter (pinhole) 406. The lens 402 and the pinhole card are confocal, which is achieved via proper alignment of the pinhole card 404.

One problem with the forward scatter detector subsystem 400 is the alignment sensitivity of the pinhole 406 to the core stream of particles. The core stream of particles can shift over time, thereby causing the center 412 to shift and reflect (bounce-back) the scattered light 410 off the pinhole card 404. When the core stream shifts over time, the small pinhole 406 needs to be shifted as well to eliminate unwanted light from reaching the detector. Therefore, a constant alignment of the pinhole 406 is needed for a confocal design to maintain a good signal-to-noise ratio. Also, if the pinhole 406 is too large, the purpose of the pinhole 406 is defeated. If the pinhole 406 is too small, the pinhole card 404 must be aligned/calibrated too often.

### Optical Fiber Forward Scatter Channel

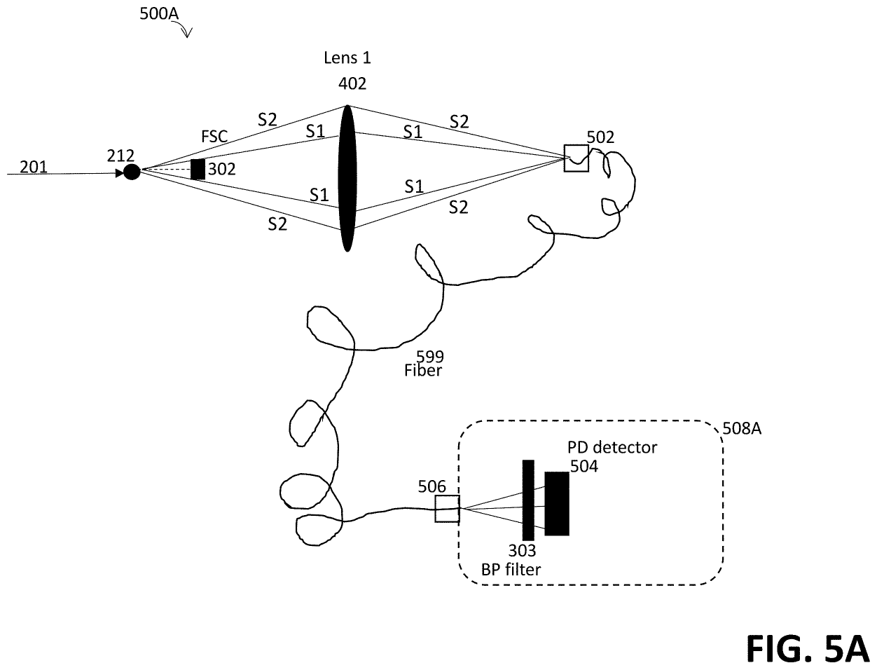

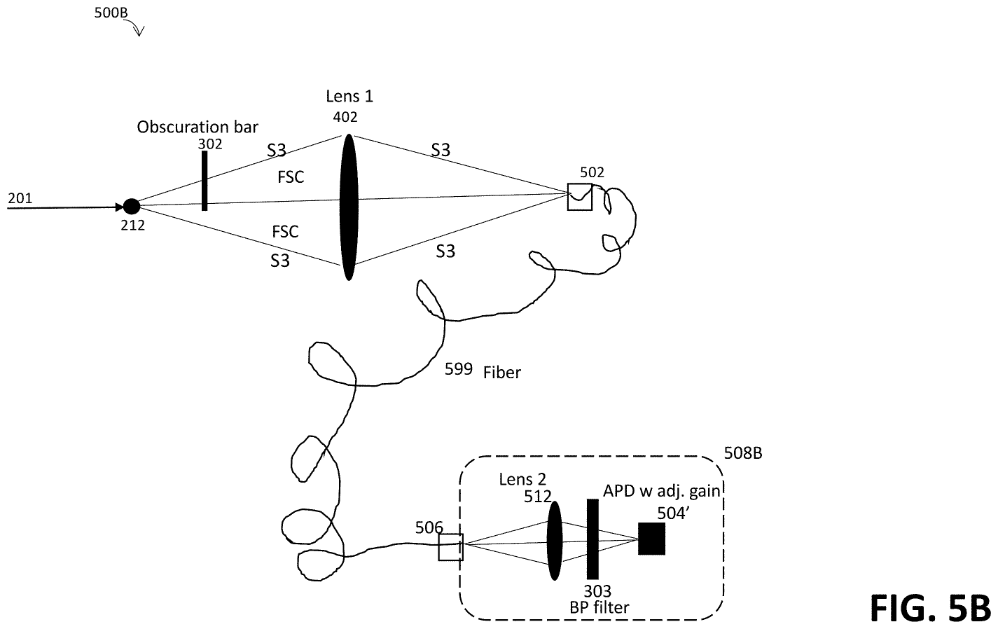

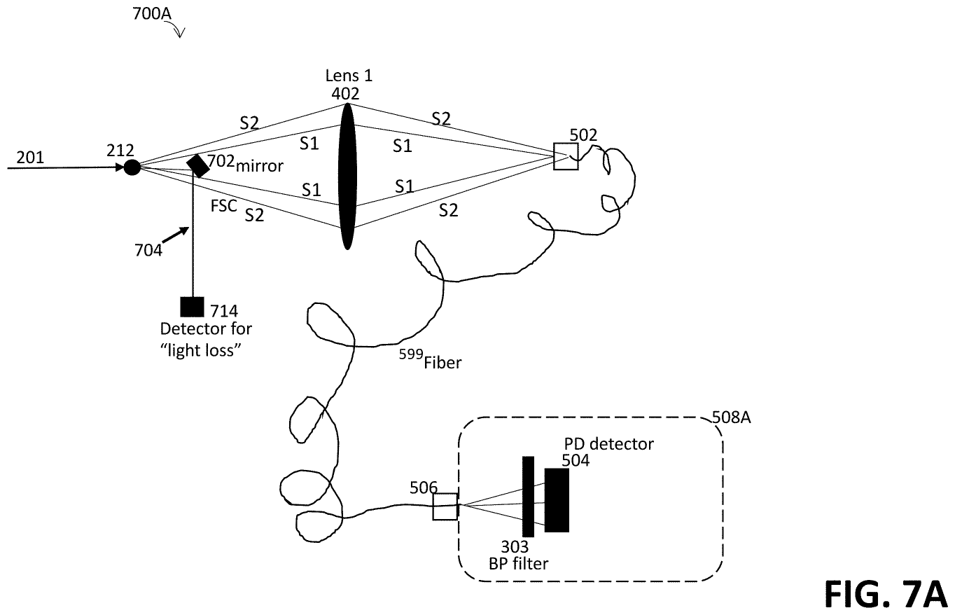

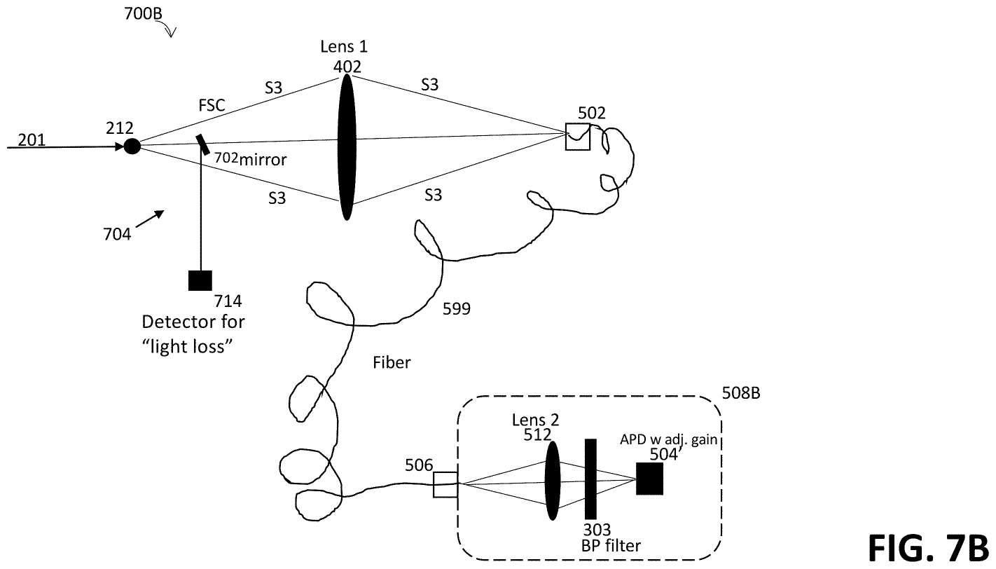

The disclosed embodiments use an optical fiber cable 504 in its forward scatter detector subsystem, such as shown in FIGS. 5A-5B and 7A-7B, instead of the pinhole card 404 of the forward scatter detector subsystem shown in FIG. 4. Advantageously, the optical fiber forward scatter detector subsystems of FIGS. 5A-5B eliminate problems discussed with reference to the forward scatter detector subsystem 400 shown in FIG. 4.

FIG. 5A is a conceptual diagram of a detector system 500A having an optical fiber 599 (e.g., fiber optic cable). The optical fiber 599 includes a fiber core having a size (diameter) that operates like an improved pinhole for spatial imaging/filtering for receiving light at an inlet. The optical fiber 599 is held in place at a receiving end by a fiber optic cable connector 502 coupled to a mechanical mount.

The obscuration bar (having a stick shape) 302 blocks the main incident laser light from interacting with a detector. When no cell/particle is present in the interrogation region (cuvette) of the flow cell, the laser light is blocked by the obscuration bar 302. Any light scattered off the obscuration bar is at an angle that is unlikely to be collected. As a cell/particle in the flow cell passes through the optical axis of the incident laser light, various portions of the cell/particle are struck by the laser light. With the cell/particle is present in the center of the interrogation region, the laser light can strike the cell/particle before the obscuration bar. The laser light refracted or forward scattered by the cell/particle passes around the obscuration bar 302 and can then be optically processed and collected/sensed.

An obscuration bar 302 can be mechanically adjustable, such as by rotation, to expose a wider or narrower bar to the laser light that respectively blocks more or less laser light from hitting a detector. To resolve or discriminate smaller particles from optical noise, it helps to block more laser light from hitting a detector when no cell/particle is present. This can be accomplished by widening the obscuration bar 302. However, the obscuration bar usually extends through a portion of the cone where scattered light is expected, such that the signal is slightly reduced as well with a wider obscuration bar.

A substantial portion of the scattered light cone S1, S2 goes around the obscuration bar 302 but for a small portion that is blocked by the extension of the obscuration bar through the cones. The substantial portion of the scattered light cone S1, S2 reaches the narrow band pass filter 303. As described herein, the band pass filter 303 has a narrow pass band of wavelengths typically centered around the desired scattered laser light that is desirous to detect. In one embodiment, the band bass filter 303 enables light with a wavelength of 488 nm (plus and minus a few nanometers) to pass through while filtering out other wave lengths outside the pass band. The band pass filter rejects the laser light of the other lasers being used in the flow cytometer system so that one forward scattered laser light is used to judge a size of a cell/particle.

To avoid the extension of the obstruction bar 302 blocking a portion of the scattered light cone S1, S2, an alternative to the obstruction bar 302 is to use an opaque obstruction film coupled directly to the face of the lens 402. An opaque circle can be used to block the main incident beam while allowing the scattered light cone S1, S2 to be imaged to the focal point of the lens.

The numerical aperture of the optical fiber 599 determines the acceptance angle of scattered light cone S1, S2. In the figures, the lines S1, S2 illustrates sizes of cones of light. As discussed with reference to FIGS. 2B and 2C, the amount of scatter and light intensity of the scattered light is inversely proportional to the diameter of the cell/particle 202. Accordingly, the scattered light S1 (which has less scatter than S2) is caused by a cell/particle that is larger than a cell/particle that causes the scattered light S2 (which has more scatter than S1). Accordingly, the detector system 500A can use light intensity and also the conical angle/size of the scattered light cone S1, S2 to calculate a size of the cell/particle 202.

If the angle of light is too large for the numerical aperture, the light will not be received by the optical fiber 599, even if the light reaches the optical fiber 599. In one configuration, the conical angles of the scattered light S1, S2 are small enough to be accepted by the optical fiber 599. In such a case, the detector system 500A would detect the particles associated with scattered light S1, S2.

However, in another configuration, the conical angle of the scattered light S2 may be too large to be accepted by the optical fiber 599, while the conical angle of the scattered light S1 may be small enough to be accepted by the optical fiber 599. In such a case, the detector system 500A would not detect the smaller particle associated with scattered light S2, while the system would detect the larger particle associated with scattered light S1.

Further, the detector system 500A can use intensity of the scattered light S1, S2 to help calculate a size of the cell/particle 202. The light intensity of the scattered light is proportional to the size of the cell/particle 202. Light that is less scattered tends to have more intensity than light that is more scattered. The less scattered light S1 (associated with a larger cell/particle) will have a higher intensity than the more scattered light S2 (associated with a smaller cell/particle).

The forward scattered light travels through the core of the optical fiber 599 from a receiving end to a launching end. At the launching end of the fiber 599, the forward scattered light is launched out of the core of the optical fiber. The forward scattered light is launched out of the face of the optical fiber into a sensor system 508A. The optical fiber 599 is held in place at the launching end by a mechanical coupler (e.g., connector, plug) 506 coupled to a mechanical mount mounted to an optical plate.

The detector system 500A includes a sensor system 508A that has a band pass filter 303 and a photodiode photodetector 504. The photodetector 504 has an adjustable gain to selectively amplify the electrical signal sensed or detected from the forward scattered light. The photodetector 504, an avalanche photodiode (APD) in one embodiment, senses the intensity of the forward scattered light that passes through the band pass filter 303. In another embodiment, an image of the conical or circular ring shaped pattern (but for a portion obscured by the obscuration bar) of the scattered light can be detected by an image detector (e.g., CCD camera device) in place of a photodiode photodetector 504. However, an image detector is typically more costly than a single photodiode.

FIG. 5B is a conceptual diagram of a slightly differ optical fiber forward scatter detector subsystem 500B having an optical fiber 599 (e.g., fiber optic cable) and an avalanche photodiode (APD) photodetector 504′. The detector system 500B is like the detector system 500A of FIG. 5A but with a different sensor subsystem. The optical fiber 599 includes a fiber core having a size that operates like an improved pinhole for spatial imaging/filtering for receiving light at an inlet. The optical fiber 599 is held in place at the inlet or receiving end to a mechanical mount by a mechanical coupler 502. The detector system 500B includes a sensor subsystem 508B that has a band pass filter 303, a lens 512 (e.g., imaging lens) and the photodetector 504′.

However, the sensor subsystem 508B includes an avalanche photodiode (APD) photodetector 504′. The APD 504′ is typically smaller and less expensive than a photomultiplier tube detector. The APD 504′ can be smaller than the typical standard photodetector 504 of the sensor subsystem 508A. The lens 512 of the sensor subsystem 508B reimages the light coming out from the optical fiber 599 into the APD 504′. The APD 504′ typically has a smaller input aperture/detector (e.g., 3 mm) compared to a photomultiplier tube input aperture/detector (e.g., 10 mm). The focal reimaging helps to reduce all of the light intensity down to strike a smaller surface area of the photodetector 504′. The smaller aperture of the photodetector 504 can further reduce background noise as well. The APD 504′ has adjustable gain (AG) through an AG amp, while a photomultiplier tube detector typically does not have adjustable gain. The APD 504′ can detect a cell/particle 202 that is smaller in size than a cell/particle that can be detected by photomultiplier tube detector.

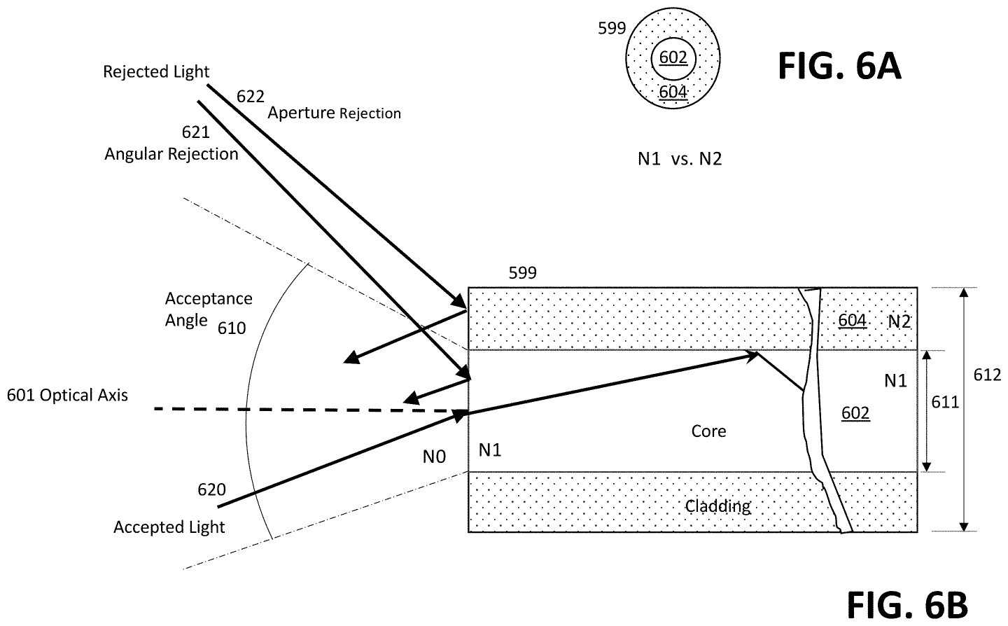

Advantageously, the optical fiber 599 enhances the filtering of unwanted scattered light from spatial and angular perspectives. This enhanced filtering eliminates the need for periodically shifting a pinhole due to fluidics drifting since angular acceptance of scattering remains unchanged, even if the core stream of light drifts over time. More details of acceptance/rejection of light are discussed with reference to FIGS. 6A-6B.

FIGS. 6A-6B illustrates views of the optical fiber 599. The optical fiber includes a core material 602 and a cladding material 604 surrounding the core material 602. The core material 602 and the cladding material 604 refract light according to Snell's Law (i.e., Snell—Descartes law and the law of refraction). The core material 602 has a first index of refraction N1, and the cladding material 604 has a second index of refraction N2. Air has an index refraction N0, typically a value of 1 in a vacuum.

The core material 602 has a circular cylindrical shape with a circular diameter 611. The cladding material 604 has a hollow circular cylindrical shape between an inner circular diameter 611 and an outer circular diameter 612. The hollow portion of the hollow circular cylindrical shape 604 receives the core material 602. The cladding material 604 has a thickness that is between the inner diameter 611 and the outer diameter 612.

The optical fiber 599 has an optical axis 601 along the center of the core 602. The optical fiber can accept light into the core 602 but not the cladding 604. The light (accepted light) 620 that can be accepted into the core 602 is over certain angles (e.g., acceptance angles 610) around the optical axis 601, based on the diameter 611 and the index of refraction N1 of the core 602, and the index of refraction NO of air. The core 602 can reject light 621 that is incident at too great an angle (greater than a critical angle) with the core, referred to as angular rejection. Anything greater than the critical angle there is light reflection off the face of the core and not light refraction into the core. Accordingly, the critical angle can also filter out light. The critical angle can be determined according to Snell's law for launching photons (light) into a cladded optical fiber (step index fiber waveguide). It is sometimes referred to as a numeric aperture (NA) calculation.

Light 622 that is incident on the cladding 604, outside the diameter 611 of the core 602, is rejected by the optical fiber. This light rejection can be referred to as aperture rejection. The circular diameter of the core of the cladded optical fiber acts like a pinhole, an aperture, and only receives a portion of the light that is incident in the circular diameter of the core. This light rejection or light filtering can be referred to as aperture rejection.

The angle of acceptance (critical angle) and the aperture establishes a cone of accepted light into the core of the optical fiber. The angle of acceptance and the aperture of the optical fiber advantageously filters out or rejects light in two ways by aperture rejection and by angular rejection. Accordingly, the optical fiber can improve forward scatter detection by rejecting more noise sources of light to improve a signal to noise ratio.

FIGS. 6A-6B illustrates views of the optical fiber 599. The optical fiber includes a core material 602 and a cladding material 604 surrounding the core material 602. The core material 602 has a first index of refraction N1 and the cladding material 604 has a second index of refraction N2. Air has an index refraction NO, typically a value of 1 in a vacuum.

The core material 602 has a circular cylindrical shape with a circular diameter 611. The cladding material 604 has a hollow circular cylindrical shape between an inner circular diameter 611 and an outer circular diameter 612. The hollow portion of the hollow circular cylindrical shape 604 receives the core material 602. The cladding material 604 has a thickness that is between the inner diameter 611 and the outer diameter 612.

The optical fiber 599 has an optical axis 601 along the center of the core 602. The optical fiber can accept light into the core 602 but not the cladding 604. The light (accepted light) 620 that can be accepted into the core 602 is over certain angles (e.g., acceptance angles 610) around the optical axis 601, based on the diameter 611 and the index of refraction N1 of the core 602, and the index of refraction NO of air. The core 602 can reject light 621 that is incident at too great an angle with the core, referred to as angular rejection. Light 622 that is incident on the cladding 604, outside the diameter 611 of the core 602, is rejected by the optical fiber, referred to as aperture rejection. The angle of acceptance and the aperture establishes a cone of accepted light into the core of the optical fiber. The angle of acceptance and the aperture of the optical fiber advantageously filters out or rejects light in two ways by aperture rejection and by angular rejection. Accordingly, the optical fiber can improve forward scatter detection by rejecting more noise sources of light to improve a signal to noise ratio.

Optical Fiber Forward Scatter Channel with a Light Loss Detection Channel

FIGS. 7A-7B illustrate optical fiber forward scatter detection subsystems 700A-700B that include similar numbered elements of the optical fiber forward scatter detection subsystems 500A-500B for which their description is incorporated here by reference. However, instead of the obscuration element 302, the scatter detection subsystems includes a light loss detector subsystem 704 of a light loss detection channel.

FIG. 7A is a conceptual diagram of an optical fiber forward scatter detection system 700A having an optical fiber 599 (e.g., fiber optic cable) and the light loss detector subsystem 704. The obscuration bar 302 normally blocks the main incident beam. A substantial portion of the scattered light S1, S2 would go around the obscuration bar 302, be band pass filtered by the filter 303 (around a laser light scattering wavelength), and detected by the photodiode (PD) detector 304. However, some portion of the forward scattered light is not detected by the photodiode (PD) detector 304. It is lost by the use of the obscuration bar 302. It can be useful to detect the light loss that would typically be caused by the obscuration bar 302. The light loss detector subsystem 704 can detect the light loss that would ordinarily be caused by an obscuration bar 302. Additionally, the light loss detector subsystem 704 can help in timing of the cells/particles that flow by when the laser light is not scattered and directly received by the photodetector with the absence of the cell/particle in the flow channel of the flow cell.

The light loss detector subsystem 704 includes a mirror 712 and another photodetector 714. The mirror 702 is placed along a center optical axis of the incoming laser beam of the laser, positioned where the obscuration bar 302 may normally be placed. The face of the mirror 702 is oriented at an angle with the center optical axis to redirect the laser light (when no cell/particle is present) and any scattered light (when cell/particle is present) into the photodetector 714. The mirror 702 redirects the light that is ordinarily obstructed by the obscuration bar 302 to the photo detector 714. For example, if the face of the mirror 702 is oriented at a 45-degree angle with the center optical axis, it causes the light to turn 90 degrees toward the photodetector 714. According, the lost scattered light that would otherwise be obscured by the obscuration bar can be detected by the photodetector 714. Furthermore, the direct laser light can be detected by the photodetector 714. The photodetector 714 is preferably a photodiode and can be an avalanche photodiode (APD).

FIG. 7B is a conceptual diagram of an optical fiber forward scatter detection subsystem 700B having an optical fiber 599 (e.g., fiber optic cable), a light loss detector subsystem 704, and an avalanche photodiode (APD) detector 504. The detector system 700B is like the detector system 700A of FIG. 7A in some ways. For those similar elements, their description is incorporated by reference. However, instead of the obscuration bar 302B, the light loss detector subsystem 704 is used. Instead of the sensor subsystem 508A, the sensor subsystem 508B is used. The sensor subsystem 508B of FIG. 7B can include a lens 512 and a small photodetector 504′. The photodetector 504′ is smaller than photodetector 504 of FIG. 5B, in order to enhance sensitivity. The smaller size detector can further reduce detected noise. The lens 512 reimages the launched light from the fiber into the smaller aperture photodetector 504′ to enhance the sensitivity. In one embodiment, the smaller aperture photodetector 504′ is an avalanche photodiode (APD) with an adjustable gain amplifier, as described with reference to FIG. 5B.

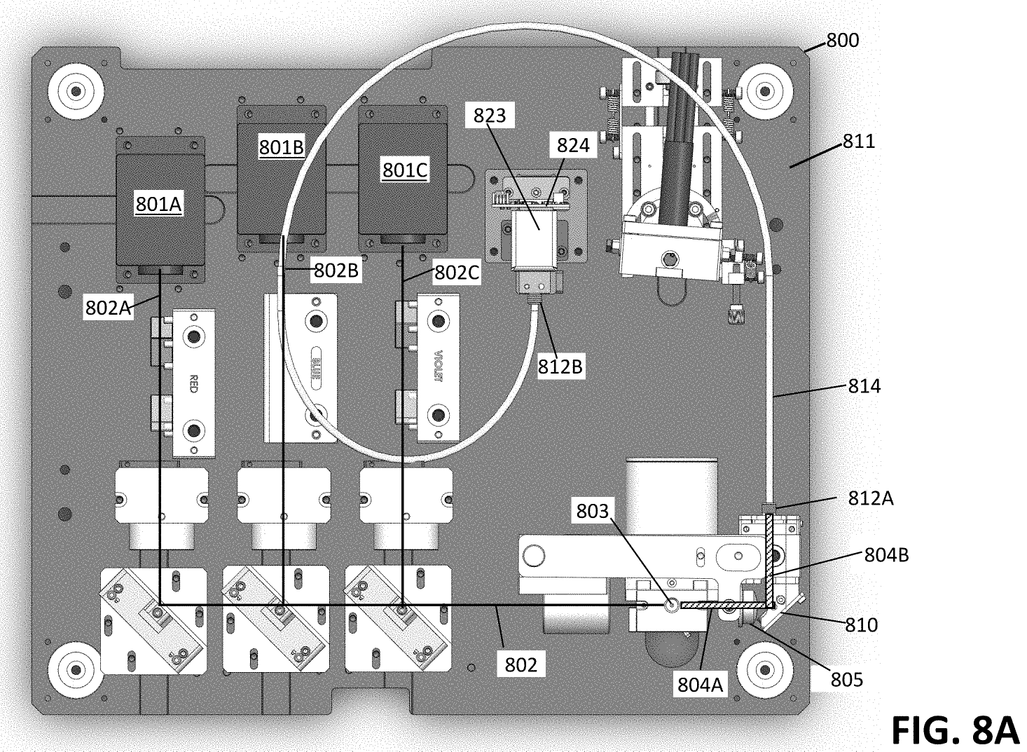

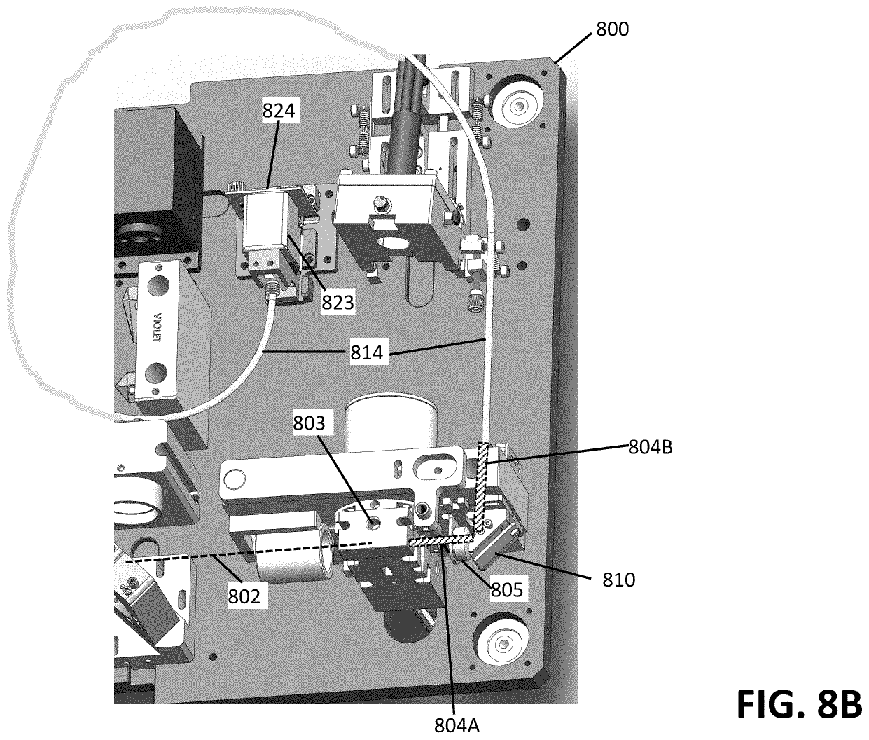

FIGS. 8A-8B illustrate portions of a flow cytometer system 800 with an optical fiber forward scatter detection subsystem. The system 800 includes one or more lasers 801A-801C mounted to a platform 811. The one or more lasers 801A-801C generate different wavelengths of laser light 802A-802C (collectively referred to as laser light 802) that are optically process by optical elements (e.g., reflected by mirrors) and directed towards cells/particles flowing through a flow cell 803. The laser light 802 when striking the cells/particles in the interrogation region of the flow cell 803 generates the various types of light expected, including forward scattered light 804A as well as side scattered light and fluorescent light, if any fluorescent markers are used with the cells/particles.

The forward scattered light 804A is focused by a lens 805 into focused forward scattered light 804B. The lens 805 is mounted to the platform and is an instance of the first lens 402. An obscuration device (obscuration bar 302 or mirror 702), not shown in FIGS. 8A-8B, can be mounted to the platform between lens 805 and the flow cell 803. The focused forward scattered light 804B can then be reflected by a mirror 810 into the focused forward scattered light 804C that is coupled into the optical fiber 814. The mirror 810 redirects the light to provide a compact the overall system 800 into a smaller footprint. Fiber optical couplers 812A-812B retain the optical fiber 814 coupled to optical fiber mounts that are mounted to the platform 811. Side scattered light and fluorescent light, if any, can be captured differently and directed to different detectors and detector arrays.

Near a photo detector 824, the focused forward scattered light 804C that is coupled into the optical fiber 814 is subsequently ejected (launched) out the opposite end of the optical fiber 814. The focused forward scattered light 804C ejected out the optical fiber 814 is coupled into one or more optical devices, such as lens 823, and then into a photo detector (avalanche photodiode) 824 mounted to the platform 811. The lens 823 is an instance of the second lens 512. The photo detector 824, an instance of the photodetector 504,504′, is a transducer that changes optical signals into electrical signals that can be further processed by a signal processor to analyze size and shape of (biological cells) particles in the flow channel 803. A bandpass filter (e.g., bandpass filter 303), not shown in FIGS. 8A-8B, can be mounted to the platform between the lens 823 and the photo detector 824.

### Advantages

There are several advantages to the fiber optic forward scatter detector channel, its assemblies, and its sub-assemblies, as part of a flow cytometer system. The fiber optic forward scatter detector channel provides significant improvement in forward scattering sensitivity. The optical fiber enhances the filtering of unwanted scattered light from spatial and angular perspectives. Via the spatial and angular filtering, the optical fiber simplifies acceptance or rejection of scattered light due to the inherent structure of the optical fiber, as compared to a conventional pin hole. This enhanced filtering eliminates the need to periodically shift a pinhole, since angular acceptance/rejection of scattering light remains substantially unchanged even if the core stream of light drifts over time.

This disclosure contemplates other embodiments or purposes. It will be appreciated that the embodiments of the invention can be practiced by other means than that of the described embodiments, which are presented in this description for purposes of illustration and not of limitation. The specification and drawings are not intended to limit the exclusionary scope of this patent document. It is noted that various equivalents for the particular embodiments discussed in this description may be practiced by the claimed invention as well. That is, while specific embodiments of the invention have been described, it is evident that many alternatives, modifications, permutations and variations will become apparent in light of the foregoing description. Accordingly, it is intended that the claimed invention embrace all such alternatives, modifications and variations as fall within the scope of the appended claims. The fact that a product, process, or method exhibits differences from one or more of the described exemplary embodiments does not mean that the product or process is outside the scope (literal scope and/or other legally-recognized scope) of the following claims.

What is claimed is:

1. A method comprising:
flowing a cell/particle in a flow cell through an optical axis of an incident laser light;
striking portions of the cell/particle with the incident laser light to generate forward scattered laser light;
focusing the forward scattered laser light into a first end of an optical fiber;
directing the forward scattered laser light towards a second end of the optical fiber; and
launching the forward scattered laser light out of the second end of the optical fiber into a sensor subsystem to detect the forward scattered laser light.

2. The method of claim 1, further comprising:
with the optical fiber, filtering out unwanted scattered light from spatial and angular perspectives.

3. The method of claim 1, further comprising:
filtering the forward scattered laser light into a pass band of wavelengths of forward scattered laser light; and
detecting an intensity of the pass band of wavelengths of forward scattered laser light.

4. The method of claim 3, wherein
the pass band of wavelengths of forward scattered laser light is in a range inclusively between 492 nanometers and 484 nanometers around 488 nanometers.

5. The method of claim 1, further comprising:
receiving the forward scattered laser light out from the second end of the optical fiber;
focally reimaging the forward scattered laser light into a photodiode detector;
filtering the focused forward scattered laser light into a pass band of wavelengths of forward scattered laser light into the photodiode detector; and
detecting an intensity of the pass band of wavelengths of forward scattered laser light.

6. The method of claim 5, further comprising:
adjusting a signal gain of the photodiode detector to detect the intensity of the pass band of wavelengths of the forward scattered laser light.

7. The method of claim 1, further comprising:
prior to the striking, blocking the incident laser light.

8. The method of claim 7, wherein
the incident laser light is blocked while the cell/particle is outside the optical axis of the incident laser light.

9. The method of claim 1, further comprising:
after the striking, blocking the incident laser light, wherein the incident laser light is blocked while the cell/particle is outside the optical axis of the incident laser light.

10. The method of claim 5, wherein
the photodiode detector is an avalanche photodiode.

11. A forward scatter light detector system comprising:
an obscuration device aligned in an optical axis of a laser to block incident laser light that is unscattered by a cell/particle;
a first lens having an optical axis aligned with the optical axis of the laser, the first lens spaced apart from an interrogation region in a flow cell of cells/particles by a first distance, the first lens spaced apart from the obscuration device by a second distance less than the first distance, the first lens to received forward scattered laser light that is scattered by the cells/particles that are struck by incident laser light;
an optical fiber having a first end and a second end opposite the first end, the optical fiber having an optical axis at the first end aligned with the optical axis of the laser, the first end of the optical fiber spaced apart from the first lens by a third distance; and
a sensor subsystem having an optical axis aligned with the optical axis of the optical fiber at the second end, the sensor subsystem to receive forward scattered laser light from the second end of the optical fiber and detect an intensity of the forward scattered laser light.

12. The forward scatter light detector system of claim 11, further comprising:
a first mechanical coupler coupled to the optical fiber near the first end to hold the first end such that the optical axis of the optical fiber is aligned with the optical axis of the laser.

13. The forward scatter light detector system of claim 11, further comprising:
a second mechanical coupler coupled to the optical fiber near the second end to hold the second end such that the optical axis of the optical fiber is aligned with the optical axis of the sensor subsystem.

14. The forward scatter light detector system of claim 11, wherein the sensor subsystem includes
a bandpass filter having a passband range of wavelengths, the bandpass filter having an optical axis aligned with the optical axis of the optical fiber at the second end, the bandpass filter spaced apart from the second end of the optical fiber to receive forward scattered laser light from the second end of the optical fiber, the bandpass filter to filter out scattered light outside the passband range and to pass through the forward scattered laser light within the passband range; and
a first photodetector having an optical axis aligned with the optical axis of the optical fiber at the second end, the first photodetector to receive the bandpassed forward scattered laser light to detect an intensity of light therein.

15. The forward scatter light detector system of claim 11, wherein the sensor subsystem includes
a second lens having an optical axis aligned with the optical axis of the optical fiber at the second end, the second lens spaced apart from the second end of the optical fiber by a fourth distance to receive forward scattered laser light from the second end of the optical fiber and focally reimage the forward scattered laser light into a focal point;
a bandpass filter having a passband range of wavelengths, the bandpass filter having an optical axis aligned with the optical axis of the optical fiber at the second end, the bandpass filter spaced apart from the second lens to receive the reimaged forward scattered laser light from the second lens, the bandpass filter to filter out scattered light outside the passband range and to pass through the forward scattered laser light within the passband range; and
an avalanche photodiode detector having an optical axis aligned with the optical axis of the optical fiber at the second end, the avalanche photodiode detector to receive the bandpassed forward scattered laser light to detect an intensity of light therein.

16. The forward scatter light detector system of claim 15, wherein
the first distance and the third distance are a focal length of the first lens; and
the fourth distance is a focal length of the second lens.

17. The forward scatter light detector system of claim 11, wherein
the obscuration device is an obscuration bar.

18. The forward scatter light detector system of claim 11, wherein
the obscuration device is an angled mirror to reflect the incident laser light along the optical axis of the laser that is unscattered by a cell/particle.

19. The forward scatter light detector system of claim 18, further comprising.
a second photodetector spaced apart from the angled mirror, the second photodetector to receive the reflected incident laser light and sense the intensity of the reflected incident laser light.

20. The forward scatter light detector system of claim 19, wherein
an optical axis of the angled mirror has a 45-degree angle with the optical axis of the laser generating the incident laser light such that the incident laser light can be perpendicularly reflected by 90 degrees into the photodetector.

21. A flow cytometer system comprising:
a platform;
a flow cell mounted to the platform;
one or more lasers mounted to the platform, the one or more lasers respectively generating one or more laser beams directed to an interrogation region in the flow cell;
a first lens having an optical axis aligned with the optical axis of the one or more lasers, the first lens spaced apart from the interrogation region in a flow cell by a first distance, the first lens to received forward scattered laser light that is scattered by cells/particles in the interrogation region that are struck by the one or more laser beams;
an obscuration device mounted to the platform between the flow cell and the one or more lasers, wherein the obscuration device is spaced apart from the first lens by a second distance less than the first distance and is aligned with the optical axis of the one or more lasers to block incident laser light that is unscattered by a cell/particle;
an optical fiber having a first end mounted to the platform and a second end opposite the first end mounted to the platform, the optical fiber having an optical axis at the first end to receive the one or more laser beams focused by the first lens, the first end of the optical fiber spaced apart from the first lens by a third distance; and
a sensor subsystem mounted to the platform having an optical axis aligned with the optical axis of the optical fiber at the second end, the sensor subsystem to receive forward scattered laser light from the second end of the optical fiber and detect an intensity of the forward scattered laser light, wherein the sensor subsystem includes
a second lens having an optical axis aligned with the optical axis of the optical fiber at the second end, the second lens spaced apart from the second end of the optical fiber by a fourth distance to receive forward scattered laser light from the second end of the optical fiber and focally reimage the forward scattered laser light into a focal point;
a bandpass filter having a passband range of wavelengths, the bandpass filter having an optical axis aligned with the optical axis of the optical fiber at the second end, the bandpass filter spaced apart from the second lens to receive the reimaged forward scattered laser light from the second lens, the bandpass filter to filter out scattered light outside the passband range and to pass through the forward scattered laser light within the passband range; and
an avalanche photodiode detector having an optical axis aligned with the optical axis of the optical fiber at the second end, the avalanche photodiode detector to receive the band passed forward scattered laser light to detect an intensity of light therein.
